(19) United States
(12) Patent Application Publication
(10) Pub. No.: US 2006/0190757 A1
(43) Pub. Date: Aug. 24, 2006

(54) Monitoring multiple clock domains

(76) Inventor: John A. Wickeraad, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/062,572

(22) Filed: Feb. 22, 2005

(51) Int. Cl. G06F 1/04

(52) U.S. Cl. 713/600

(57) ABSTRACT

Methods, systems, and circuits are provided for monitoring multiple clock domains. One method for monitoring multiple clock domains includes pipelining different sets of signals from different clock domains on an application specific integrated circuit (ASIC) to a particular input/output (I/O) port on the ASIC using an associated clock from each different clock domain, and selecting a particular set of signals from among the different sets of signals to send out of the particular I/O port.

Application specific integrated circuits (ASICs) may use a set of input/output (I/O) pins to observe internal signals for monitoring, observation, counting, and debug, among other functions. Such I/O pins or “ports” are sometimes referred to as monitor/observation/debug ports. Typically, these ports view signals from the perspective of one clock domain. In some cases, a particular port may allow signals to be viewed “live” without going through any flip-flops. In some instances, no debug operations are performed on some clock domains such as on smaller clock domains, but rather, are focused on the main or core clock domain. This does not allow for signals to be observed in the other clock domains if there is a problem.

### BRIEF DESCRIPTION OF THE DRAWINGS

FIG. 1 illustrates a block diagram for a computing system environment including a number of ASICs.

FIG. 2 illustrates an embodiment of a system for monitoring multiple clock domains.

FIG. 3 illustrates an embodiment of a system for monitoring multiple clock domains.

FIG. 4 illustrates an embodiment for signal crossing multiple clock domains.

### DETAILED DESCRIPTION

Embodiments of the invention cover methods, systems, and circuits for signal crossing multiple clock domains. One method embodiment includes monitoring multiple clock domains. The example method includes pipelining different sets of signals from different clock domains on an application specific integrated circuit (ASIC) to a particular input/output (I/O) port on the ASIC using an associated clock from each different clock domain. The method also includes selecting a particular set of signals from among the different sets of signals to send out of the particular I/O port. The different sets of signals in the destination clock domain can be monitored and observed by a logic analyzer, oscilloscope, and/or other test equipment.

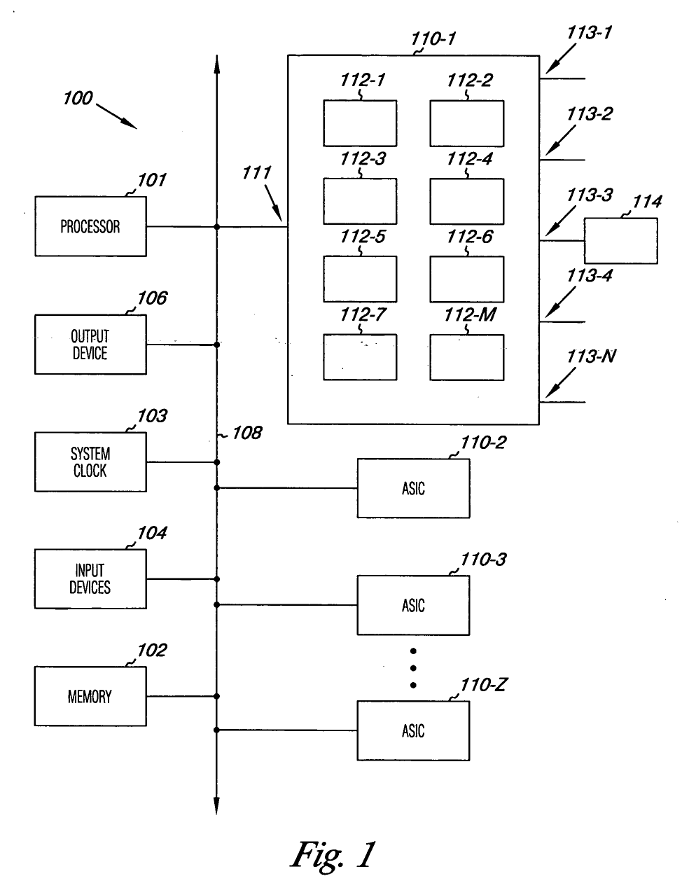

FIG. 1 illustrates a block diagram for a computing system environment including a number of ASICs. As shown in FIG. 1, a computing system can include one or more system processors 101, one or more memories 102, one or more system clocks 103, one or more input devices 104, and one or more output devices 106. Such components can be connected together via a system bus 108, for example. One of ordinary skill in the art will appreciate the variety and types of components that may be included in a computing system. And, accordingly, more detail is not provided here so as not to obscure the embodiments of this disclosure.

As shown in the embodiment of FIG. 1, a number of application specific integrated circuits (ASICs), 110-1, 110-2, 110-3, . . . , 110-Z, may be included in the computing system 100. The designator “Z” is used to indicate that a number of ASICs may be included with a given computing system 100.

As illustrated with example ASIC 110-1, a given ASIC can include a number of different clock domains, 112-1, . . . , 112-M, having similar and/or dissimilar clock frequencies. The designator “M” is used to indicate that a number of different clock domains may be included with a given ASIC 110-1. On ASIC 110-1 each of the “M” different clock domains can have a different clock associated therewith.

So, for example, one clock domain 112-1 may have a different clock frequency from another clock domain, e.g., 112-2. The clock associated with clock domain 112-2 may again be different from the clock associated with clock domain 112-3. At the same time, a clock associated with a given clock domain may be equivalent to the clock used in another clock domain. For example, the clock associated with clock domain 112-5 may have the same clock frequency as the clock associated with clock domain 112-6. Embodiments are not limited to the examples described here in connection with ASIC 110-1.

As shown in FIG. 1, example ASIC 110-1 includes one or more inputs connected to the bus 108, shown generally for ease of illustration as 111. Additionally, example ASIC 110-1 includes a number of I/O pins, or ports, 113-1, . . . , 113-N which can be connected to other components or circuits. The designator “N” is used to indicate that a number of I/O pins or ports (hereinafter referred to as “ports”) may be included with a given ASIC 110-1.

As shown in the embodiment of FIG. 1 and described in more detail below, at least one I/O port, e.g., port 113-3, can be connected to a logic analyzer 114 as the same are known and understood by one of ordinary skill in the art to monitor, observe, and/or debug signals from various ones of the clock domains 112-1, . . . , 112-M on the ASIC 110-1. ASICs 110-2, 110-3, . . . , 110-T, can include similar circuit configurations to that discussed in connection with ASIC 110-1. Embodiments, are not limited to the example illustration provided in FIG. 1.

The pipelining or routing of signals from several of the different clock domains 112-1, . . . , 112-M to an area of a particular I/O port, e.g., 113-3, on the ASIC 110-1 for monitoring, observation, and/or debug by a logic analyzer, e.g., 114, is described in more detail below.

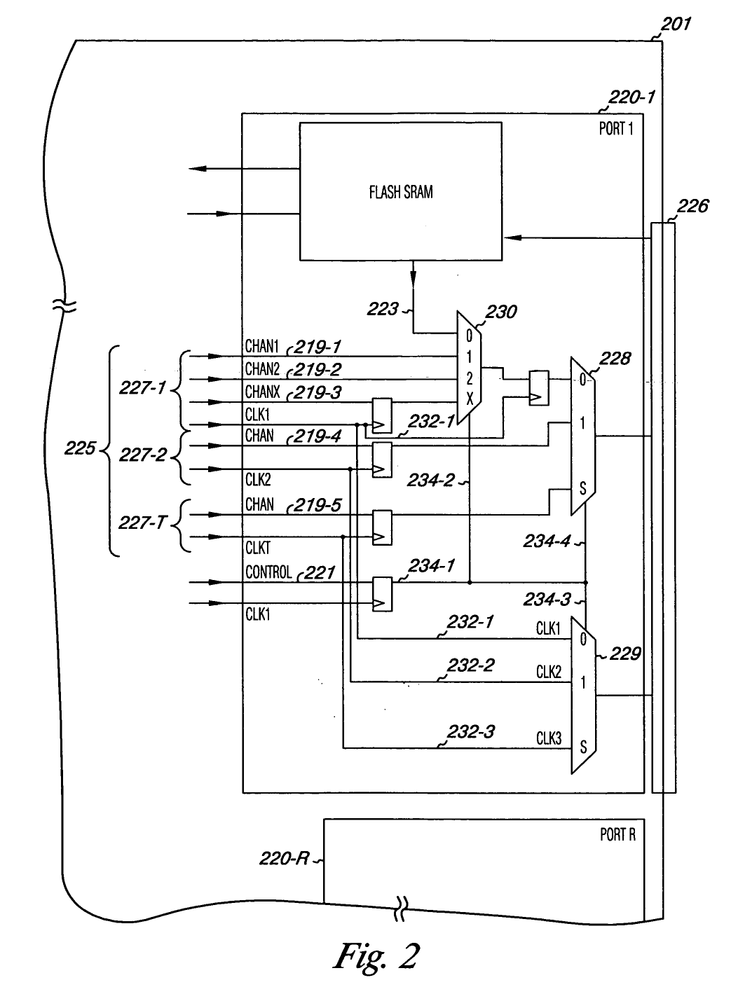

FIG. 2 illustrates an embodiment of a system for monitoring multiple clock domains. FIG. 2 provides an ASIC 201 having a number of different clock domains being pipelined to an area of a particular I/O port, e.g., 113-3, on the ASIC 110-1 for monitoring, observation, and/or debug by a logic analyzer, e.g., 114, as shown in FIG. 1.

FIG. 2 illustrates an example embodiment of three different clock domains being pipelined to the particular I/O port 226 for port logic 220-1 of a number of port logic modules 220-1, . . . 220-R. The pipelining or routing signals from several of the different clock domains 227-1, . . . , 227-T to an area of a particular I/O port, e.g., 226, on the port logic 220-1, for monitoring, observation, and/or debug by a logic analyzer, can involve connecting the different clock domains 227-1, . . . , 227-T to one or more multiplexers which can selectively choose which set of signals to output to the logic analyzer.

In the embodiment illustrated in FIG. 2, for example, three multiplexers 228, 229, and 230 are provided to aid in the selection of the clock domains to be operated on. The multiplexer 228 selects which channel to be routed to the I/O port 226. As used herein a channel represents a set of signals. In the embodiment provided in FIG. 2, the multiplexer 228 has access to five channels that can be selected from, namely 219-1, . . . , 219-5. Channels 219-4 and 219-5 can be selected directly by multiplexer 228.

With respect to the other channels, in the embodiment shown, a pre-selection is made by multiplexer 230 and that selection is provided to the multiplexer 228. Multiplexer 230 selects one or more channels 219-1, 219-2, 219-3, and a flash static random access memory (SRAM) channel 223 in which to route on to multiplexer 228. Such embodiments, having a pre-selection multiplexer can be useful, for example, when the channels to be pre-selected exist in the same clock domain.

Embodiments can also be used where the I/O port 226 can provide signals other than those associated with clock signals. For example, as shown in FIG. 2, a flash SRAM channel 223 can be selected by multiplexer 230 and can thereby be routed to the I/O port 226. In some embodiments, the flash SRAM channel 223 can be directed to the multiplexer 228. Those of ordinary skill in the art will understand from reading the present disclosure that signals providing various other functions (e.g., SRAM channel 223, among other functions for providing debug, monitoring, observation, and/or counting, among others) can be routed through a multiplexer, such as multiplexer 230 of FIG. 2.

Multiplexer 229 selects which clock is to be used with the channel that has been selected by multiplexer 228. In this way, a clock signal corresponding to the channel selected can also be selected. The control of the multiplexers and, therefore, the selections made thereby, can be accomplished through use of one or more control signals 221. The control signals can be used to instruct one or more of the multiplexers which of the channels or clock signals is to be routed through to the I/O port 226.

The controller can provide instructions in a variety of formats. For example, an instruction can be one or more bits of data. For instance, the multiplexer can receive a two bit instruction (e.g., having a value such as 0, 1, 2, or 3) indicating the routing of information that is assigned to a channel corresponding to that number. In the illustrated case, a 0 represents the flash SRAM channel 223, a 1 represents channel 219-2, a 2 represents channel 219-1, and an N represents channel 219-3. In this example the N can represent any value and is used to indicate that multiplexers can be used to select from various numbers of channels. These control signals can be provided to the multiplexers via connections 234-1, 234-2, and 234-3, for example.

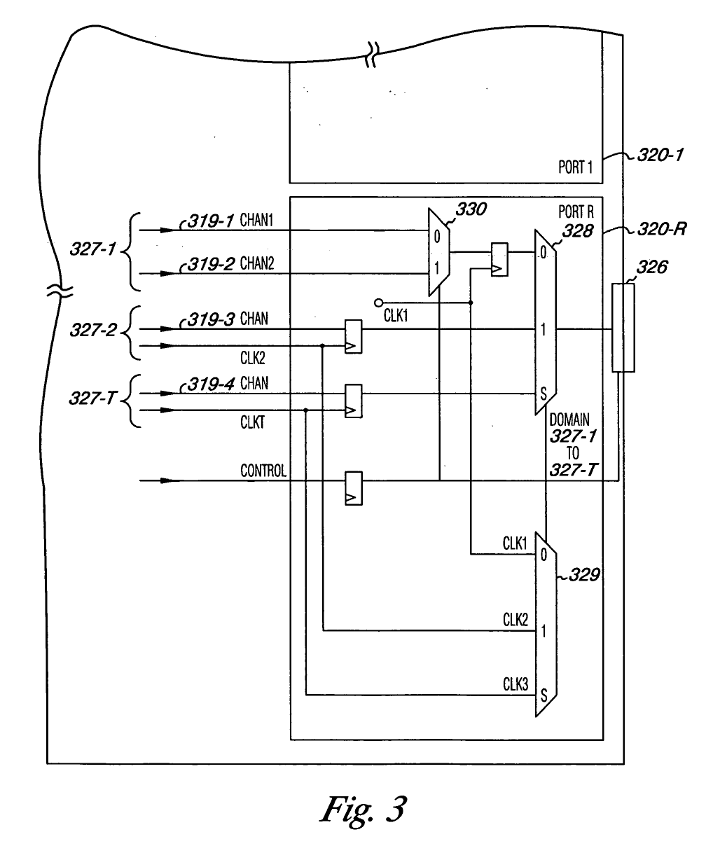

FIG. 3 illustrates an embodiment of a system for monitoring multiple clock domains. In the embodiment of FIG. 3, as with the embodiment shown in FIG. 2, a number of different clock domains being pipelined to an area of a particular I/O port. FIG. 3 illustrates an example embodiment of three different clock domains being pipelined to the particular I/O port 326 for port logic 320-R of a number of port logic modules 320-1, . . . , 320-R. The pipelining or routing signals from several of the different clock domains 327-1, . . . , 327-T to an area of a particular I/O port, e.g., 326, on the port logic 320-R for monitoring, observation, counting, and/or debug by a logic analyzer can involve connecting the different clock domains 327-1, . . . , 327-T to a multiplexer which can selectively choose which set of signals to output to the logic analyzer.

In this embodiment, a multiplexer 330 pre-selects from channels 319-1 and 319-2 which of these two channels will be routed to the multiplexer 328. In addition to the channel selected by multiplexer 330, the multiplexer 328 also selects from channels 319-3 and 319-4. These channels are routed directly to multiplexer 328. The clock signal that corresponds to the selected channel is selected by multiplexer 329. As with the embodiment of FIG. 2, the control of the various multiplexers and their selection of the channels and clock signals can be provided by one or more control signals.

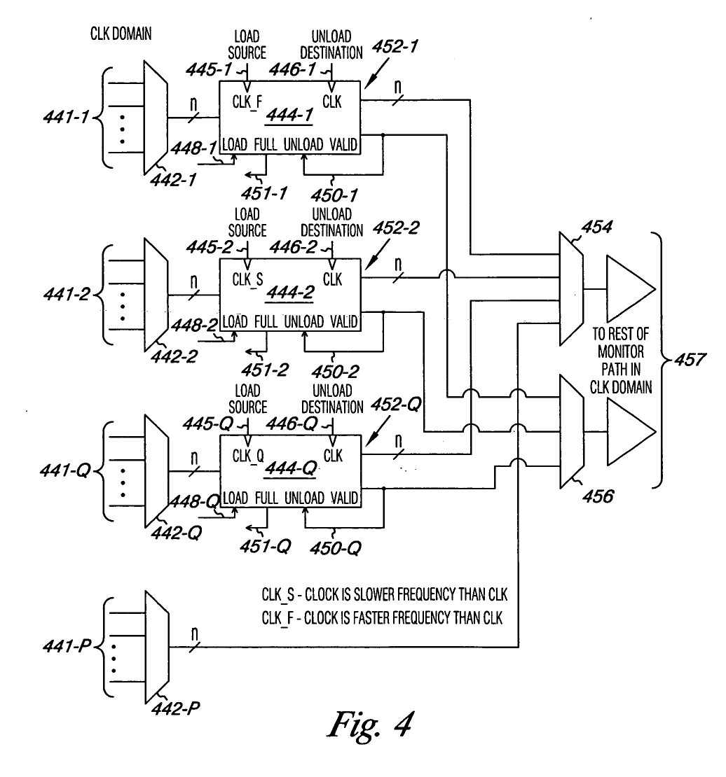

Monitoring of multiple clock domains can be aided through use of a number of signal crossing FIFOs. Such embodiments are described briefly with respect to FIG. 4 herein and are described in detail in co-pending, commonly assigned application by the same inventor, entitled, “Signals Crossing Multiple Clock Domains”, docket no. 200408009-1, incorporated herein in full by reference.

As the reader will appreciate, the embodiments of the invention can use localized signal crossing FIFOs, e.g., 444-1, . . . , 444-Q as shown in FIG. 4, to move data from the clock domain of interest to a destination clock domain such that any and all clock domains on a given ASIC can be monitored, observed, counted, and/or debugged. In some embodiments, different sets of signals from one or more clock domains (e.g., one or more smaller clock domains) can be moved to the another clock domain (e.g., a main or core clock domain, such as the destination clock domain) before being moved to a monitoring, observation, and/or debug port. In other embodiments, multiple internal signals from a subset on the number of different clock domains of multiple frequencies can be moved directly to a monitoring, observation, and/or debug port in a different clock domain.

The embodiment of FIG. 4 includes a number of clock domains 441-1, . . . , 441-P on an ASIC such as the multiple clock domains 112-1, . . . , 112-M shown on ASIC 110-1 in FIG. 1. Within each respective clock domain, different sets of signals can be connected to a multiplexer, shown as 442-1, . . . , 442-P respectively, to selectively choose which signals from within that clock domain are of interest, e.g., for monitoring, observation, debug, etc.

The output of each multiplexer 442-1, . . . , 442-Q for clock domains 441-1, . . . , 441-P, are input to a signal crossing FIFO, illustrated as 444-1, . . . , 444-Q respectively. In each case the signal crossing FIFO includes a clock input associated with a particular, different clock domain (represented in FIG. 4 as “CLK”) as well as a clock input for the clock frequency of the source clock domain, e.g., 441-1, . . . , 441-Q, connected to the signal crossing FIFO 444-1, . . . , 444-Q. In the illustrative example of FIG. 4 the CLK, or clock associated with a destination clock domain, is the clock frequency of clock domain 441-P. Embodiments, however, are not limited to this example.

As shown in the example embodiment of FIG. 4, each signal crossing FIFO 444-1, . . . , 444-Q includes a load signal 448-1, . . . , 448-Q to communicate when data from the associated multiplexer 442-1, . . . , 442-Q is valid and the associated signal crossing FIFO, 444-1, . . . , 444-Q is not full in order to load signals into the signal crossing FIFO 444-1, . . . , 444-Q. Each signal crossing FIFO 444-1, . . . , 444-Q includes a set of data output signals 452-1, . . . , 452-Q, and a valid output signal 450-1, . . . , 450-Q indicating when a set of data output signals 452-1, . . . , 452-Q is valid.

One of ordinary skill in the art will appreciate upon reading this disclosure the manner in which signals from one clock domain can be input to a signal crossing FIFO to be output according to another clock frequency. For an example illustration of the same reference is made to commonly assigned, issued U.S. Pat. No. 6,208,703, issued to Cavanna et al., Mar. 27, 2001, which is incorporated herein in full by reference.

In the illustrative embodiment of FIG. 4, the clock frequency of clock domain 441-2 has an associated clock frequency which is a slower clock frequency (shown as “CLK_S” clock input) than CLK, i.e., the clock associated with the destination clock domain 441-1. In other words, for signal crossing FIFO 444-2 “the clock (CLK) associated with the destination clock domain” has a higher clock frequency than “a clock associated with the source clock domain”, e.g., clock domain 441-2. And, in the example of FIG. 4 the clock frequency of clock domain 441-1 has an associated clock frequency which is a faster clock frequency (shown as “CLK_F” clock input) than CLK.

In other words, for signal crossing FIFO 444-1 “the clock (CLK) associated with the destination clock domain” has a lower clock frequency than “a clock associated with the source clock domain”, e.g., clock domain 441-1. The designator “Q” is used to indicate that a number of different clock domains may be provided with signal crossing FIFOs including a clock (CLK) associated with a particular, different, e.g., destination, clock domain on a given ASIC 110-1. In the example of FIG. 4, the clock frequency of clock domain 441-Q has an associated clock frequency which may be slower, faster, and/or roughly the same but the clock phase may be unknown. For instance, it is noted that even though different clock domains may have the same clock frequency the phase alignment may be unknown. In such cases, a signal crossing FIFO may be used to treat the clock domains as having different frequencies. Embodiments are not limited to these examples illustrated in FIG. 4.

As noted above, within each respective clock domain 441-1, . . . , 441-P, different sets of signals can be connected to a multiplexer, shown as 442-1, . . . , 442-P. In each respective clock domain the multiplexer 442-1, . . . , 442-P can select, from among the different sets of signals received thereto, which signals from within that clock domain are of interest, e.g., for monitoring, observation, counting, debug, etc. In the example embodiment of FIG. 4, each multiplexer 442-1 . . . , 442-Q selects a set of signals of “n” bits to send as input to the associated signal crossing FIFO 444-1, . . . , 444-Q. The reader will appreciate that each multiplexer 442-1, . . . , 442-Q can be controlled by circuitry, not shown, which exists in the source clock domain. For example, the control circuitry can be provided by configuration registers that a processor can write to as the same is known and understood in the art. The designator “n” is used to indicate that a signal of a variable word width, e.g., 16 bits, can be chosen according to design rule. Embodiments, however, are not limited to the example of 16 bit widths.

In the example of FIG. 4 it is also shown that the multiplexer 442-P for clock domain 441-P, having the clock used by the FIFOs 444-1, . . . , 444-Q as the CLK (i.e., clock associated with the destination clock domain) similarly selects a set of signals of “n” bits from among different sets of signals received to the multiplexer 442-P in clock domain 442-P. A selected set of signals is loaded as input to a given signal crossing FIFO 444-1, . . . , 444-Q upon receiving a load signal 448-1, . . . , 448-Q from its associated signal crossing FIFO 444-1, . . . , 444-Q. As the reader will appreciate, the source clock domain can include circuitry, not shown, which asserts the load signal at the appropriate time, e.g., whenever the FIFOs 444-1, . . . , 444-Q are not full. The load signal 448-1, . . . , 448-Q is usually asserted when the associated clock crossing FIFO 444-1, . . . , 444-Q is not full, as indicated by full signals 451-1, . . . , 451-Q. However, in some embodiments the load signal 448-1, . . . , 448-Q can include other qualifiers such as when a set of signals is valid.

In the above example for clock domain 441-2 a selected set of signals selected from among the different sets of signals received to the multiplexer 442-2 could be loaded into the signal crossing FIFO 444-2 each clock cycle of the clock associated with the destination clock domain, e.g., 441-P, since the signal crossing FIFO 444-2 can be unloaded faster than the rate at which data is arriving thereto. In this example, the signal crossing FIFO 444-2 can be relatively small in size, e.g., four word entries would suffice to capture all of the input data and synchronize to the destination clock domain.

As will be appreciated by the reader, data output signals 452-1, . . . , 452-Q can be unloaded from these signal crossing FIFOs 444-2 and 444-Q every cycle there is valid data in the FIFO. Thus, the valid output signals 450-1, 450-2, . . . , 450-Q are illustrated as input back into the clock crossing FiFOs 444-1, . . . , 444-Q to unload the FIFOs.

In the above example for clock domain 441-1 a selected set of signals selected from among the different sets of signals received to the multiplexer 442-1 can be loaded into the signal crossing FIFO 444-1 when there is room available in the signal crossing FIFO 444-1, i.e., the “full signal” 451-1 is not asserted. In this scenario, selected signals may be dropped or “lost” since the signal crossing FIFO 444-1 cannot unload data as fast as the rate at which data is arriving thereto, i.e. CLK is slower than CLK_F. That is, as the reader will appreciate, pointers have to be synchronized to the destination clock domain and there has to be enough word entries that each set of signals can go through the FIFO without being dropped.

Moreover, in the case where the signal crossing FIFO 444-1 is full and data may be potentially lost, an overflow signal 451 could be written to the signal crossing FIFO 444-1. For example, the source clock domain can have a state machine, not shown, which detects a “full” state, e.g., there was valid data that couldn't be loaded into the FIFO. As the reader will appreciate, such a state machine could keep a bit to indicate this state and set an overflow signal which could be stored/read by a processor later. Similarly, the overflow signal could be written to the FIFO if the word width is widened by a bit. The next time signals were loaded to the FIFO the overflow bit could be set and passed along out of the FIFO to the destination clock domain.

In one embodiment of the above example for clock domain 441-1 a selected set of signals selected from among the different sets of signals received to multiplexer 442-1 can be loaded into to signal crossing FIFO 444-1 upon receipt of a load signal 448-1. In this scenario, the load signal 448-1 is asserted to load selected signals from multiplexer 442-1 at a rate which will not overflow the signal crossing FIFO 444-1 based on a difference between the CLK frequency of the signal crossing FIFO (i.e., the frequency at which the signal crossing FIFO unloads data) and the clock frequency of the faster clock domain 441-1.

A valid output signal 450-1, . . . , 450-Q will be asserted every cycle there is valid data in the FIFOs 444-1, . . . , 444-Q. This signal will indicate when a data output signal 452-1, . . . , 452-Q is valid. As the reader will appreciate the valid output signals 450-1, . . . , 450-Q can indicate a valid set of data output signals from the signal crossing FIFOs 444-1, . . . , 444-Q.

As shown in the example embodiment of FIG. 4, the set of data output signals 452-1, . . . , 452-Q from each of the signal crossing FIFOs 444-1, . . . , 444-Q is connected to a multiplexer 454 to be selected and connected to the destination clock domain and/or to the rest of a signal path in a monitor, observe, counting, and/or debug path 457. A valid output signal 450-1, . . . , 450-Q is also connected to a multiplexer 456. And, similarly, the valid output signals 450-1, . . . , 450-Q can be selected by multiplexer 456 and connected to the destination clock domain and/or to the rest of a signal path in a monitor, observe, counting, and/or debug path 457. That is, in some embodiments, the signal path 457 can connect to an area of a particular I/O port, e.g., 113-3, on the ASIC 110-1 for monitoring, observation and/or debug by a logic analyzer, e.g., 114, as shown in FIG. 1.

Thus, it has been shown that the set of data output signals and valid output signals from multiple clock domains can be properly synchronized and connected to an embedded logic analyzer and/or a counter, as the same are known and understood, in a destination clock domain 441-P. As the reader will appreciate, counters are often provided in one clock domain of an ASIC and are useful for counting how many times events happen on the ASIC. Desirably, the counter would be provided in as fast a clock domain as possible. It will also be appreciated that after the set of data output signals and valid output signals have been moved to a particular destination clock domain they can be provided to buffers 457 to pipeline particular port on the ASIC used for monitoring, observation, and/or debugging, as illustrated more in FIG. 3, for example.

Although specific embodiments have been illustrated and described herein, those of ordinary skill in the art will appreciate that an arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for monitoring multiple clock domains, comprising:
pipelining different sets of signals from different clock domains on an application specific integrated circuit (ASIC) to a particular input/output (I/O) port on the ASIC using an associated clock from each different clock domain; and
selecting a particular set of signals from among the different sets of signals to send out of the particular I/O port.

2. The method of claim 1, wherein the method includes using a multiplexer to select the particular set signals from among the different sets.

3. The method of claim 1, wherein the method-includes using the multiplexer to select the associated clock for the particular set of signals from among the different sets.

4. The method of claim 1, wherein the method includes using test equipment to observe the particular set signals.

5. A method for monitoring multiple clock domains on an application specific integrated circuit (ASIC), comprising:
pipelining different sets of signals from different clock domains on the ASIC to a particular input/output (I/O) port on the ASIC using an associated clock from each different clock domain; and
using a multiplexer to select a particular set of signals from among the different sets of signals to send out of the particular I/O port.

6. The method of claim 5, wherein the method includes pipelining different sets of signals from at least two different clock domains on the ASIC.

7. The method of claim 5, wherein the method includes pipelining different sets of signals from different clock domains on the ASIC to a particular I/O port which is shared as a flash random access memory (RAM) port and as a monitoring port.

8. The method of claim 7, wherein the method includes using a multiplexer to select between using the particular I/O port as the flash RAM port and using the particular I/O port as the monitoring port.

9. The method of claim 5, wherein the method includes pipelining different sets of signals from different clock domains on the ASIC to a single I/O port used for debugging signals in the different clock domains.

10. A method for monitoring multiple clock domains on an application specific integrated circuit (ASIC), comprising:
pipelining different sets of signals from at least two different clock domains on the ASIC to a particular I/O port which is shared as a flash random access memory (RAM) port and as a monitoring port using an associated clock from each different clock domain;
using a first multiplexer to select between using the particular I/O port as the flash RAM port and using the particular I/O port as the monitoring port; and
using a second multiplexer to select a particular set of signals from among the different sets of signals to send out of the particular I/O port and to select the associated clock for the particular set of signals, when the particular I/O port is being used as the monitoring port.

11. The method of claim 10, wherein the method includes using a at least three to one multiplexer as the second multiplexer to select the particular set of signals and the associated clock for the particular set of signals.

12. The method of claim 10, wherein the method includes pipelining different sets of signals from a first, a second, and a third clock domain on the ASIC.

13. The method of claim 12, wherein pipelining a set of signals from the first clock domain includes pipelining signals from a core clock domain on the ASIC and includes signals from other clock domains which have been multiplexed at the core clock domain by a signal crossing first in first out (FIFO).

14. The method of claim 13, wherein the pipelining a set of signals from the second clock domain includes pipelining signals from a clock domain which has a different clock frequency from the first clock domain.

15. The method of claim 14, wherein pipelining a set of signals from the third clock domain includes pipelining signals from a clock domain which has a different clock frequency from the first and the second clock domains.

16. An application specific integrated circuit (ASIC), comprising:
a number of different clock domains located on different portions of the ASIC;
a number of input/output (I/O) ports to connect signals to and from the ASIC;
circuitry to pipeline different sets of signals from the different clock domains to a particular input/output (I/O) port on the ASIC along with an associated clock from each of the different clock domains; and
a multiplexer connecting the circuitry to the particular I/O port, wherein the multiplexer can select a particular set of signals from among the different sets of signals to send out of the particular I/O port.

17. The ASIC of claim 16, wherein the multiplexer includes an input to selectably control the particular set of signals which is connected to the particular I/O port.

18. The ASIC of claim 17, wherein the multiplexer can select the associated clock for the particular set of signals from among the different sets of signals from the different clock domains.

19. The ASIC of claim 16, wherein the particular I/O port is connected to a logic analyzer to observe the particular set signals.

20. An application specific integrated circuit (ASIC), comprising:
a number of different clock domains located on different portions of the ASIC;
a number of input/output (I/O) ports to connect signals to and from the ASIC;
circuitry to pipeline different sets of signals from at least two different clock domains on the ASIC, along with an associated clock from each of the different clock domains, to a particular I/O port which is shared as a flash random access memory (RAM) port;
a first multiplexer to select between using the particular I/O port as the flash RAM port and using the particular I/O port as the monitoring port; and
a second multiplexer connecting the circuitry to the particular I/O port, the second multiplexer to select a particular set of signals from among the different sets of signals to send out of the particular I/O port and to select the associated clock for the particular set of signals, when the particular I/O port is being used as the monitoring port.

21. The ASIC of claim 20, wherein the second multiplexer is a four to one multiplexer to select the particular set of signals and the associated clock for the particular set of signals from at least four different clock domains.

22. The ASIC of claim 20, wherein the circuitry pipelines different sets of signals from a first, a second, and a third clock domain on the ASIC.

23. The ASIC of claim 22, wherein the circuitry pipelines a set of signals from the first clock domain which is a core clock domain on the ASIC, and wherein the set of signals pipelined from the first clock domain includes signals from other clock domains which have been multiplexed at the core clock domain by a signal crossing first in first out (FIFO).

24. The ASIC of claim 23, wherein the circuitry pipelines a set of signals from the second clock domain which has a different clock frequency from the first clock domain.

25. The ASIC of claim 24, wherein the circuitry pipelines a set of signals from the third clock domain which has a different clock frequency from the first and the second clock domains.

26. An application specific integrated circuit (ASIC), comprising:
a number of different clock domains located on different portions of the ASIC;
a number of input/output (I/O) ports to connect signals to and from the ASIC;
means for pipelining different sets of signals from the different clock domains to a particular input/output (I/O) port on the ASIC along with an associated clock from each of the different clock domains; and
means for selecting a particular set of signals from among the different sets of signals to send out of the particular I/O port.
